(19) United States
(12) Patent Application Publication
(10) Pub. No.: US 2025/0390718 A1
(43) Pub. Date: Dec. 25, 2025

(54) AUTOMATIC QUERY ENHANCEMENT AND ESTIMATE GENERATION

(71) Applicant: INTUIT INC., Mountain View, CA (US)

(72) Inventors: Parmanand MOURYA, Bangalore (IN); Isham RAJGARIAH, Bangalore (IN); Ram Karteek YERUBANDI, Bangalore (IN); Gautam VR, Bangalore (IN); Sandeep MEWARA, Bangalore (IN); Pradeep Kurunimakkil LAXMINARAYANA, Bangalore (IN)

(73) Assignee: INTUIT INC., Mountain View, CA (US)

(21) Appl. No.: 18/751,111

(22) Filed: Jun. 21, 2024

(51) Int. Cl. G06N 3/0475; G06F 16/22; G06Q 10/10

(52) U.S. Cl. CPC G06N 3/0475; G06F 16/2291; G06Q 10/103

(57) ABSTRACT

At least one processor can obtain active time data indicating a duration of work on a project in a software product and preparation time data indicating additional elapsed time between a start and an end of the project. The at least one processor can convert the active time data and the preparation time data into a data entry having a standardized format and store the data entry in a database. The at least one processor can identify context data in the database. The at least one processor can generate a large language model (LLM) prompt comprising a structured combination of a query, the database entry, and the context data, send the LLM prompt to an LLM, and receive a response from the LLM. The at least one processor can validate the response and, in response to the validating, send the response to the software product.

### BACKGROUND

Traditional query response systems often rely on static databases and algorithms such as lookup schema to generate responses. These systems may lack the flexibility to adapt to new types of queries or to learn from past interactions. Accordingly, these systems are increasingly being replaced with and/or augmented by large language model (LLM) and/or other machine learning (ML) technologies. However, while LLMs have demonstrated success at answering some types of queries, they have struggled with others.

### BRIEF DESCRIPTIONS OF THE DRAWINGS

FIG. 1 shows an example estimation system according to some embodiments of the disclosure.

FIG. 2 shows an example estimation process according to some embodiments of the disclosure.

FIG. 3 shows an example query data gathering process according to some embodiments of the disclosure.

FIG. 4 shows an example vector generation process according to some embodiments of the disclosure.

FIG. 5 shows an example query generation process according to some embodiments of the disclosure.

FIG. 6 shows an example response validation process according to some embodiments of the disclosure.

FIG. 7A shows an example response object generation process according to some embodiments of the disclosure.

FIG. 7B shows a first example response according to some embodiments of the disclosure.

FIG. 7C shows a second example response according to some embodiments of the disclosure.

FIG. 8 shows an example feedback reinforcement process according to some embodiments of the disclosure.

FIG. 9 shows an example computing device according to some embodiments of the disclosure.

### DETAILED DESCRIPTION OF SEVERAL EMBODIMENTS

Embodiments described herein may provide automated systems and methods that can perform enhanced processing on inputs to and/or outputs from LLM and/or other generative artificial intelligence (GenAI) to enable these systems to function well in contexts in which they may otherwise perform poorly. For example, some embodiments can enable an LLM to estimate work information for users such as tax preparers (e.g., an amount of time it will take to prepare a tax return and make it e-file ready, capacity to onboard new clients, need to onboard more employees, etc.).

Preprocessing techniques described herein can enable integration of such GenAI systems with various products in a manner that is agnostic to product data formatting and presentation. Moreover, preprocessing and postprocessing techniques described herein can add feedback learning and/or other enhancement techniques above and beyond those used by the GenAI to improve future queries in a product data agnostic manner. Accordingly, the disclosed systems and methods provide technical solutions to problems of integrating LLM interactions with context enrichment into products in a format agnostic manner and/or verifying/improving LLM responses.

Examples discussed herein are presented in the context of a tax preparation product using LLM queries to educate tax preparers on the amount of time they are spending (e.g., how much time did they spend on tax filings for a given client and/or all clients), predict how much time it will take for similar clients and similar accountants, and/or estimating required time commitments for current clients and identifying room for growth and onboarding. However, it should be understood that the disclosed systems and methods can be used in other contexts and/or with other products and/or queries in similar fashion.

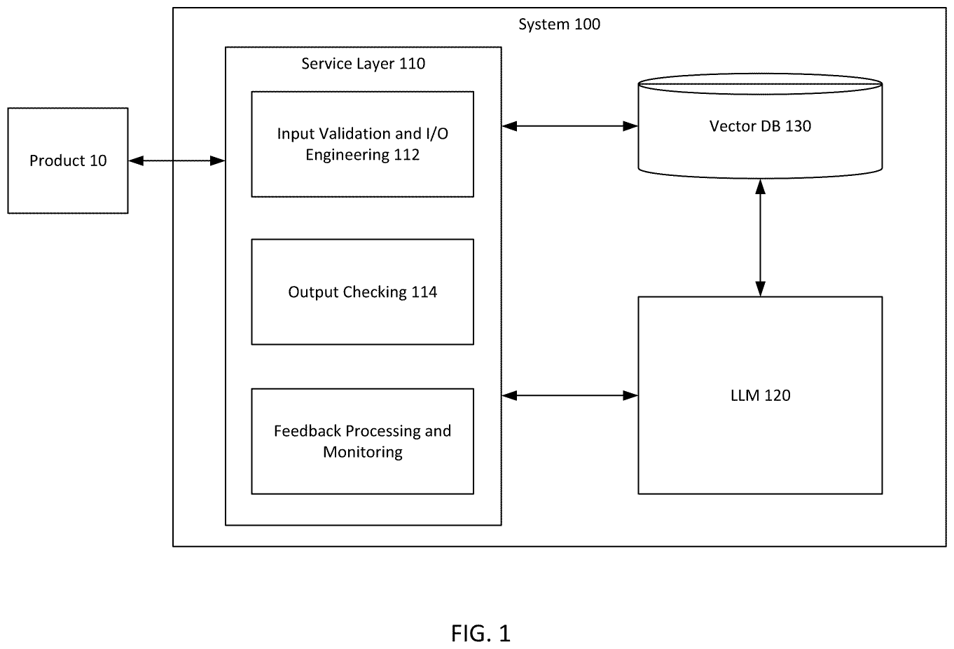

FIG. 1 shows an example estimation system 100 according to some embodiments of the disclosure. System 100 may include service layer 110, LLM 120, and/or vector database (DB) 130. In some embodiments, LLM 120 and/or vector DB 130 may be components of system 100 (e.g., may be co-located or otherwise coupled with service layer 110), while in other embodiments, LLM 120 and/or vector DB 130 may be separate from service layer 110 (e.g., hosted externally, provided by third parties, etc.) and in communication with service layer 110. Service layer 110 may include input validation and input/output (I/O) engineering module 112, output checking module 114, and/or feedback processing and monitoring module 116, the features and functions of which are described in detail below. In some embodiments, system 100 may include additional modules (not shown) that are commonly included in customer service platforms and/or other modules. As described in detail below, system 100 may interact with product 10, which may be co-located or otherwise coupled with system 100 and/or may be in remote communication with system 100 (e.g., provided by a web server or executed by a client device) to receive query requests, provide query responses, and/or otherwise facilitate interaction between product 10 and LLM 120.

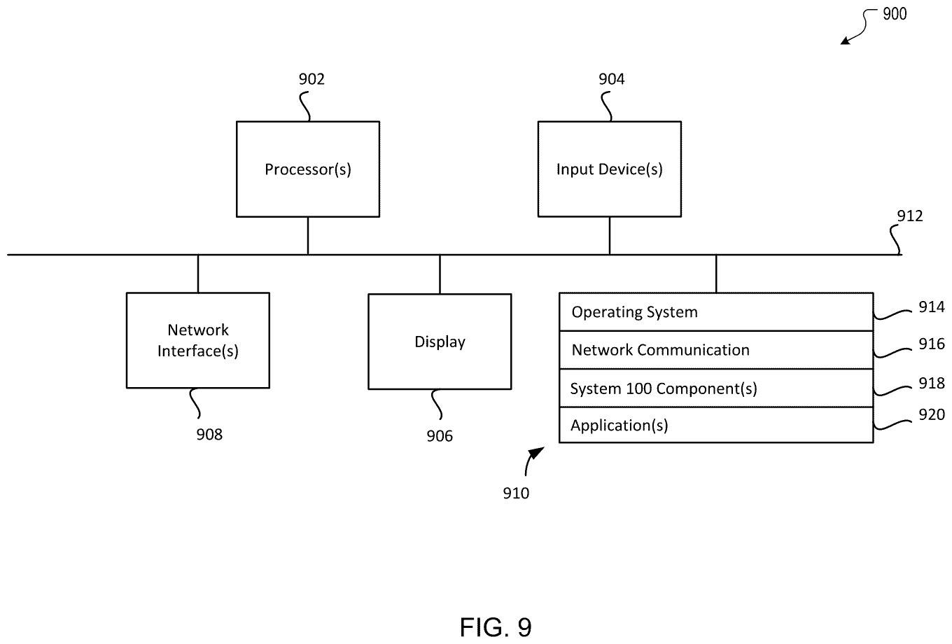

Illustrated components may include a variety of hardware, firmware, and/or software components that interact with one another. Some components shown in FIG. 1 may communicate with one another using networks. For example, product 10 may access system 100 through one or more networks (e.g., the Internet, an intranet, and/or one or more networks that provide a cloud environment). In another example, service layer 110 may use one or more networks to communicate with one or both of LLM 120 and vector DB 130. Each component may be implemented by one or more computers (e.g., as described below with respect to FIG. 9).

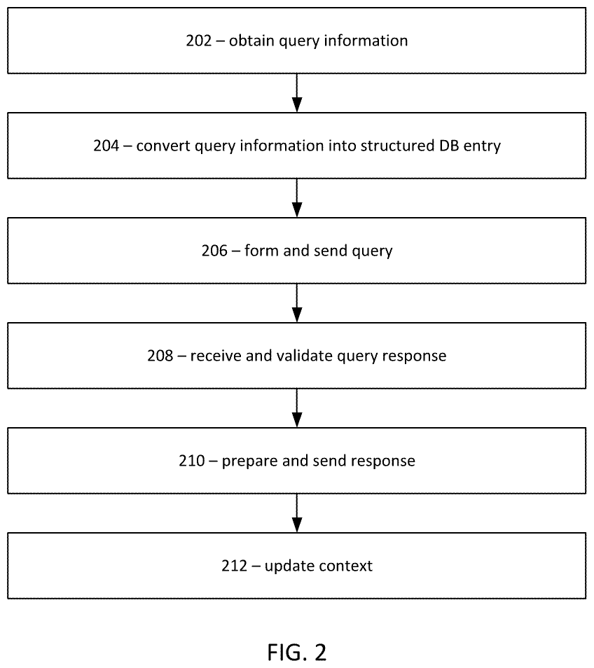

The elements of system 100 and functions thereof are described in greater detail below with respect to FIGS. 2-8. but in general, service layer 110 may receive and process queries from product 10, which may include the use of vector DB 130, before providing prompts based on the queries to LLM 120. Service layer 110 may also receive query responses from LLM 120 and process the responses before providing them to product 10. Examples of query processing may include, but are not limited to, validating queries, vector conversion using embeddings to generate vectors from the queries, and/or enriching queries. Examples of response processing may include, but are not limited to, validating responses, generating response payloads, and/or storing response data as future context data.

Product 10 may be any software, hardware, firmware, or combination thereof that can use the enhanced query generation and response validation processing of system 100. An example product 10 discussed herein is tax preparation software used by accountants on behalf of client filers, but various other products 10 that include functionality for interfacing with LLMs could be substituted in various embodiments.

Service layer 110, as described in detail herein, can act as a liaison between product 10 and LLM 120. Product 10 can send natural language queries to service layer 110. Service layer 110 can perform input validation and I/O engineering (e.g., generating an enhanced prompt in a required format with added data such as context data, checking for errors and security issues, sending to LLM 120). Service layer 110 can check LLM 120 responses for hallucination and/or appropriateness and, if validation passes, send responses to product 10, or send other messages in the event of validation failure. Service layer 110 and/or other elements of system 100 can perform telemetry, observation, and monitoring processing such as reentering responses into vector DB 130 and using the reentered responses as future context to make responses better in the future.

LLM 120 can be any large language model, including off-the-shelf models such as ChatGPT and/or proprietary models. LLM 120 can process queries sent by service layer 110 and send response.

Vector DB 130 can be any vector database, such as Open Search or other products. Vector DB 130 can store data in a standard format, such as query data and/or context data, as described in detail herein.

Elements illustrated in FIG. 1 (e.g., system 100 (including service layer 110 and its modules (input validation and I/O engineering module 112, output checking module 114, and feedback processing and monitoring module 116), LLM 120, vector DB 130) and product 10) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one product 10, one system 100 with one service layer 110, LLM 120, and vector DB 130, and one of each module (e.g., input validation and I/O engineering module 112, output checking module 114, and feedback processing and monitoring module 116) are illustrated, this is for clarity only, and multiples of any of the above elements may be present. In practice, there may be single instances or multiples of any of the illustrated elements, and/or these elements may be combined or co-located. For example, system 100 may interact with multiple products 10 and may employ multiple LLM 120 instances and/or types and/or vector DB 130 instances and/or types.

In the following descriptions of how the illustrated components function, several examples are presented, including examples using specific data or data types such as tax preparation data and timing data for completing tax filings. However, those of ordinary skill in the art will appreciate that these examples are merely for illustration, and the disclosed embodiments are extendable to other application and/or data contexts.

FIG. 2 shows an example estimation process 200 according to some embodiments of the disclosure. System 100 may perform estimation process 200 and thereby provide enhanced query processing in combination with LLM system(s) (e.g., LLM 120). For example, process 200 can include normalizing a query from a software product to be format agnostic, enhancing the query with context-specific data, validating LLM-generated responses to the enhanced query, and providing the response in a format that is specifically configured for the product.

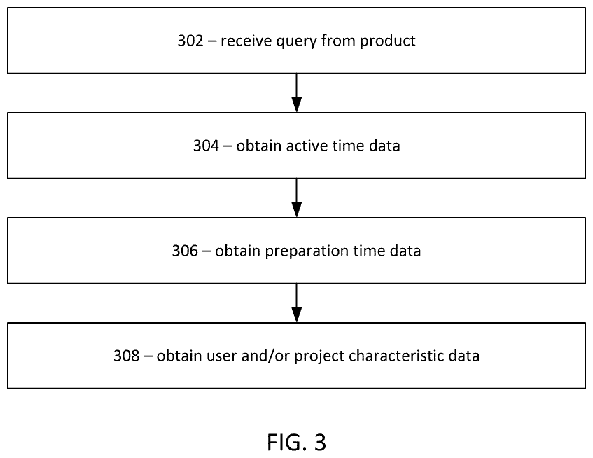

At 202, service layer 110 may obtain query information from product 10. Query information can include a user query entered by a user in a user interface (UI) of product 10. For example, product 10 may provide a UI including a field for entering natural language queries or the like. When a user enters a query, product 10 may send the query to system 100 (e.g., to service layer 110). Service layer 110 may obtain additional information relevant to the query, such as active time data indicating a duration of work on a project in the product 10, preparation time data indicating additional elapsed time between a start and an end of the project, and/or other data. An example process for obtaining query information is described below with respect to FIG. 3.

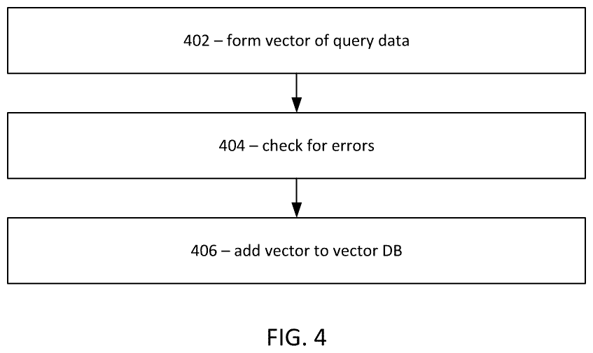

At 204, service layer 110 may convert the query information and/or other information received at 202 into a structured form compatible with vector DB 130, such as a vector. For example, system 100 may be configured to work with a specific product 10 or a variety of different products 10. In the latter case, different products 10 may provide query information in different data formats. Even in the former case, product 10 characteristics may change over time, including changes to query information data format. Accordingly, service layer 110 may apply text embeddings stored by vector DB 130 to the query information received at 202, thereby normalizing the query information into a structured form. An example process employing text embeddings is described below with respect to FIG. 4.

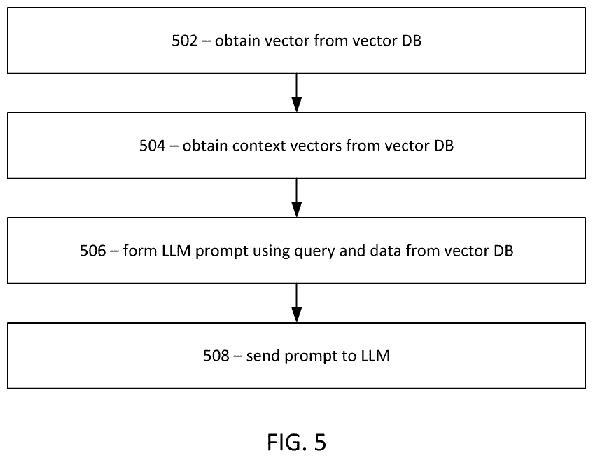

At 206, service layer 110 may form an enhanced query and send it to LLM 120. For example, service layer 110 can identify context data in vector DB 130 and generate an LLM prompt comprising a structured combination of the query information and/or the database entry and/or the context data, as obtained and/or created at 202-204. Service layer 110 can send the LLM prompt to LLM 120. An example process for creating and sending LLM queries is described below with respect to FIG. 5.

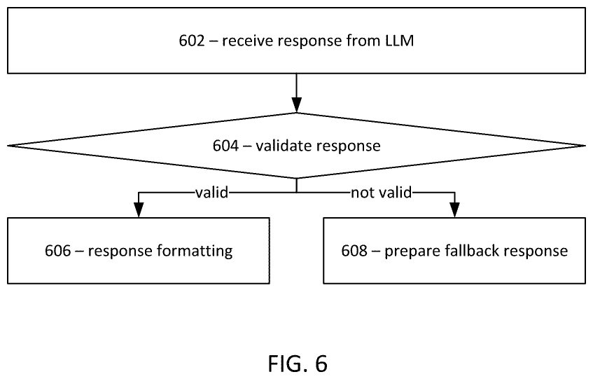

At 208, service layer 110 may receive a response from LLM 120 and validate the response. For example, LLM 120 can process the enhanced LLM query sent at 206 and generate a response according to its internal algorithm, training data, and/or tuning parameters. Service layer 110 can validate the response using one or more ML algorithms and/or static checks. An example process for receiving and validating LLM responses is described below with respect to FIG. 6.

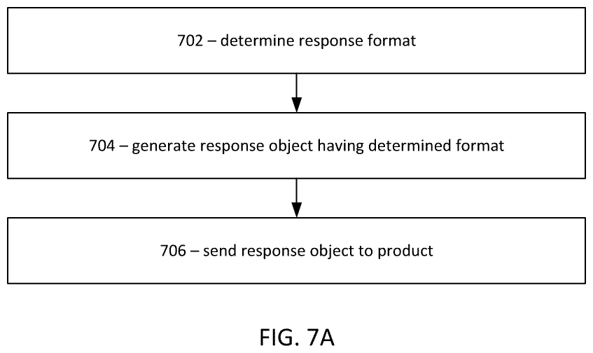

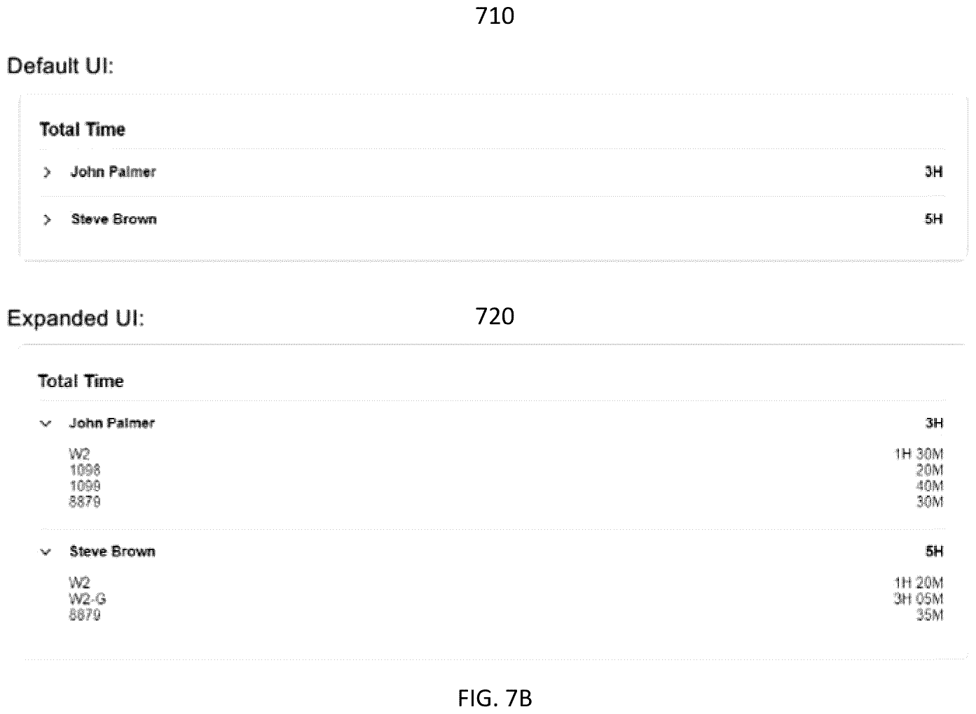

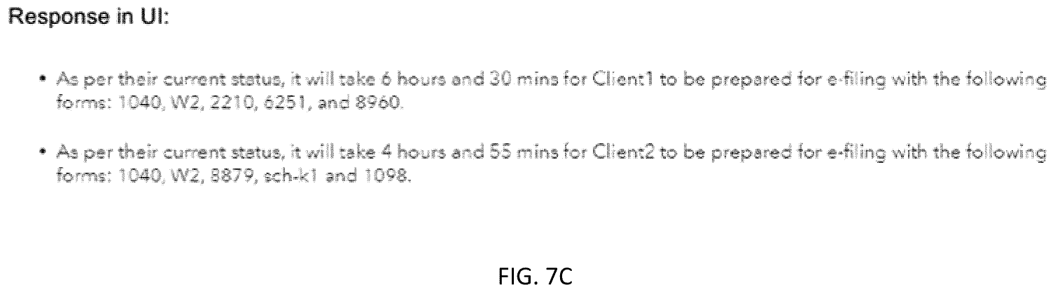

At 210, service layer 110 may prepare a formatted response and send it to product 10. For example, service layer 110 can determine a format that is required or requested by product 10, generate a response having the format, and send the response to product 10. An example process for preparing and sending a formatted response is described below with respect to FIG. 7.

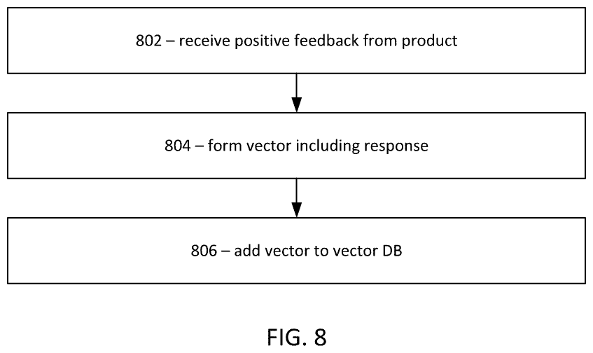

At 212, service layer 110 may update context data in vector DB 130. For example, product 10 may elicit feedback on the quality of the response from the user through the UI. Product 10 can send any feedback provided by the user to system 100 (e.g., service layer 110). Service layer 110 can process the feedback and, if appropriate based on the feedback, add data related to the query and response to the vector DB 130 as context for future queries. An example process for updating context data is described below with respect to FIG. 8.

FIG. 3 shows an example query data gathering process 300 according to some embodiments of the disclosure. In some embodiments, system 100 may perform process 300 at 202 of process 200 in order to obtain query information and/or other data that can be used to generate an enhanced query.

At 302, service layer 110 may receive a query from product 10. For example, a user can enter a query into a UI element provided by product 10. Product 10 can send the query to service layer 110. In some embodiments, the query may be free-form data such as a text question typed or spoken by a user, and as such may have any content. In some embodiments, the UI can provide guidance, such as by indicating what types of questions are answerable by the LLM 120. At any rate, the query can come from the user and, at least in some cases, can be related to a task performed within product 10. For example, if product 10 is tax preparation software, the user might ask questions about how much time they will need to prepare on some tax preparation tasks and/or whether they have capacity for additional work, etc. (e.g., “I have ten tax returns to prepare, and last year it took me a month. Do you think it will be similar this year (e.g., in view of changed efile rules, client details, etc.)?”).

At 304, service layer 110 may obtain active time data. The active time data can include a record of active user interaction with the project in the software product. For example, product 10 may include functionality to record active time worked generally and/or on a given project. Product 10 may store data indicating the active time locally and/or elsewhere. When a query is received from a user at 302, product 10 can include the active time data with the query sent to service layer 110, or service layer 110 can request the active time data in response to receiving the query from product 10.

Using the tax preparation example, active time may represent the time that the preparer has spent actively working within product 10 on a given return preparation. Active time may be calculated for each return. Time during which the preparer is idle or not working on the return can be omitted as part of the active time calculation. For example, when the preparer opens the return in the UI, product 10 may start an active timer. Based on the activity or inactivity, product 10 may start or stop the timer, respectively. Product 10 may report the time to service layer 110. Once the return is closed, product 10 and/or service layer 110 may save the total elapsed time in a persistence object, so that in the event of future cycles of open/close, product 10 and/or service layer 110 can update the value each time until electronic filing is complete.

At 306, service layer 110 may obtain preparation time data. The preparation time data can include a record of at least a portion of an elapsed time between an initiation of the project and a completion of the project. For example, product 10 may include functionality to record active time elapsed between the start of a project and the end of the project or, if the project is in progress, a current time. Elapsed time may be different from active time in at least some instances, for example encompassing time between when a document was sent out for client signature and when it was received, time during which filings were in the mail, etc. Product 10 may store data indicating the preparation time locally and/or elsewhere. When a query is received from a user at 302, product 10 can include the preparation time data with the query sent to service layer 110, or service layer 110 can request the preparation time data in response to receiving the query from product 10.

Using the tax preparation example, preparation time may represent the total time that the preparer has spent on the particular return from the time of return creation to the time it is ready for filing. For example, when the preparer opens the return in the UI, product 10 may start a preparation timer and on closing may stop the timer. Product 10 may report the time to service layer 110. Once the return is closed, product 10 and/or service layer 110 may save the total elapsed time in a persistence object, so that in the event of future cycles of open/close, product 10 and/or service layer 110 can update the value each time until electronic filing is complete. Unlike active time, the preparation time timer may capture idle and/or non-working time.

At 308, service layer 110 may obtain user and/or project characteristic data. For example, product 10 may store and/or maintain user profiles for respective users of product 10. Users can log in and operate product 10 while logged in, which can allow product 10 to collect and/or build a user profile. The user profile can include data such as user title (e.g., admin, principal, employee, etc.), product use information (e.g., power user, infrequent user, etc.), experience level, etc. Product 10 may store and/or maintain project characteristics such as complexity levels (e.g., one type of tax return may be more complex than another type, etc.), requirements, progress, status, and/or other information about respective project types (e.g., total number of mandatory fields, list of forms required, error count, percent completion, etc.). When a query is received from a user at 302, product 10 can include the user and/or project characteristic data with the query sent to service layer 110, or service layer 110 can request the user and/or project characteristic data in response to receiving the query from product 10.

Using the tax preparation example, product 10 may report a variety of user and/or project characteristic data to service layer 110. For example, during electronic filing, service layer 110 may capture a list of forms added in the return and, where applicable, a count of forms used for each type of form in the list. Service layer 110 may capture a percentage completion of the tax return, which may be calculated by any known technique. Service layer 110 may capture any errors in any fields or calculations in the filing data reported by product 10.

FIG. 4 shows an example vector generation process 400 according to some embodiments of the disclosure. In some embodiments, system 100 may perform process 400 at 204 of process 200 in order to generate a vector for the query data and/or other data obtained at 202, where the vector is a structured database entry as described above. By generating a vector, system 100 can normalize the data in the query and/or obtained through process 300 so that it can be included in an enhanced query.

At 402, service layer 110 may form a vector of the query data and/or other data. For example, service layer 110 can create a vector that includes the query and/or any other data gathered by process 300 or by a similar process, such as active time data, preparation time data, and/or user and/or project characteristic data. To form the vector, service layer 110 may provide the data to vector DB 130 along with a command to apply an embedding function of a text embedding model stored by vector DB 130. The text embedding model may specify a standardized format for storing data, and the embedding function may insert the provided data into the format in a consistent manner regardless of input format. Vector embedding may use any known or novel embedding generation model such as Jina-embeddings-v2-base-en, OpenAI's ada-002, or the like. Accordingly, any time process 400 is performed, the resulting vector has a standardized format. For example, data obtained by process 300 may be in various formats (e.g., PDF, HTML, text files, etc.) and may originate at a variety of sources (e.g., websites, databases, etc.), any of which may vary by product 10 and/or other variable conditions. Because the text embedding model serves to normalize the data, subsequent processing described below may be performed the same way regardless of original data format.

At 404, service layer 110 may check the vector for errors. For example, prior iterations of prompt engineering efforts may have identified example vectors that perform well when the vector is well structured and inserted into a prompt that itself is structured to work with the vector. The vector generated at 402 may be compared with the example vectors or an extrapolated format thereof to ensure compliance with the high-performing format. The format may be defined through a vector DB schema. As a non-limiting example, the following schema in Table 1 may allow tracking of time taken for each formset within a document in a tax preparation process, considering the profile of the person filling the document. The schema can provide a structured way to analyze completion times based on different profiles and formsets, which can be valuable for performance evaluation and process optimization.

TABLE 1

| Column Name | Data Type | Description |
|---|---|---|
| DocumentID | INT | A unique identifier for each |
| | | document. |
| FormsetName | VARCHAR | Name or identifier for the formset |
| | | within the document (e.g., |
| | | “Personal Information”, |
| | | “Employment History”). |
| FormsetID | INT | Unique identifier for each formset |
| | | within the document. |
| NumberOfForms | INT | Number of forms within the formset. |
| ProfileID | INT | Unique identifier for the person |
| | | filling the document. |
| Profile Type | VARCHAR | Type of profile, such as employee, |
| | | customer, or student. |
| ProfileCategory | VARCHAR | Additional categorization of the |
| | | profile, such as department or |
| | | age group. |
| StartTime | DATETIME | Timestamp indicating when the |
| | | person started filling the formset. |
| EndTime | DATETIME | Timestamp indicating when the |
| | | person finished filling the formset. |
| TimeTaken | INT | Duration taken by the person to |
| | | complete the formset (calculated as |
| | | EndTime-StartTime). |

At 406, if no errors have been found, or if errors have been corrected, service layer 110 may add the vector to vector DB 130.

FIG. 5 shows an example query generation process 500 according to some embodiments of the disclosure. In some embodiments, system 100 may perform process 500 at 206 of process 200 in order to generate an enhanced query prompt and send it to LLM 120. The enhanced query prompt can improve the quality of responses by LLM 120, even when LLM 120 is not modifiable through tuning, training, or alteration of internal algorithms.

At 502, service layer 110 may obtain the vector generated by process 400 or another process from vector DB 130. For example, service layer 110 can include the normalized vector version of the user's query in the enhanced query information, because the ultimate goal of processing described herein may be, at least in part, to provide an answer to a user's actual question.

At 504, service layer 110 may obtain context vectors from vector DB 130. Context vectors may include, for example, at least one record of a previously successful data entry in the standardized format that resulted in a previously validated response from LLM 120. As described in detail below, when LLM 120 provides a successful response that has been validated as acceptable and/or indicated as acceptable by a user of product 10, service layer 110 may store a vector including at least the query in vector DB 130. The vector may further include additional information such as the LLM 120 answer and/or other context information.

At 506, service layer 110 may form an LLM prompt using the vectors obtained at 502 and 504, which may be a form of retrieval augmented generation (RAG) in at least some embodiments. The prompt can include the query from product 10 and the vectors obtained at 502 and 504 and may be engineered according to a predetermined format or schema. In some embodiments, setup of system 100 may include testing engineered prompts to identify a format or schema that consistently causes LLM 120 to provide valid responses, and the identified format or schema may be used to engineer prompts at 506. At 508, service layer 110 may send the prompt to LLM 120.

As a non-limiting example, service layer 110 may form and send the following LLM prompt for a question about estimated preparation time in the tax preparation context:

```
JavaScript
{
      “conversationId”: “GUID”,
  ″messages″: [
      // system prompt
      {″role″: ″system″, ″content″: ″You are a helpful bot that answers
questions based on the context and chat history provided.″},
      // chat history
      {″role″: ″user″, ″content″: ″I have 2 client returns, one with income
from W2 & 1098 and other from W2 and W2-G. Can you estimate the time it'll take for
me to complete the EFile for these returns?″},
      {″role″: ″assistant″, ″content″: ″The first and second client will take3
days and 5 days respectively.″},
      // User query
    {
        ″role″: ″user″,
        ″content″: ″Given the current state of client John Palmer,
what time am I looking at to make it e-file ready?″,
        ″metadata″: {
          ″chat_model″: ″gpt-35-turbo-v0301″,
          ″max_tokens″: 1000,
          ″temperature″: 0.7,
          ″query_configs″: {
            ″size″: 5,
            ″pre_filter″: { profileID: 123456 }
            },
            ″embedding_model″: ″jina-embeddings-v2-base-
en″
          }
      }
    }
    // Few Shot Examples
      ″few_shot_examples″: [
            ″what is the time client return x will take to make
it ready for EFile″,
            ″why the time is this high?″,
            ″i want to know the time taken by each form″,
            ″could you tell me what time it'll take to prepare
the1040 return from the start to end?″,
            ″could you tell me why client x is taking more
time than client y”,
            ″in current state of client return x, what is the
time I am looking to make it efile ready?″,
            “show me the time details for each return for
current state”
          }
    }
  }
```

In some embodiments, input validation may be performed as part of the prompt generation. Input validation can determine if the query is something that can be passed as input and/or can provide security against prompt injection (e.g., to avoid manipulation of the LLM to supply restricted data with prompt injection). The prompt can include at least three parts, the system prompt that is part of the LLM, the user prompt that is the query from the user, and the few-shot examples (e.g., see the example prompt above). Few-shot examples may be a set of examples that the LLM can use to determine which type of questions it needs to answer, so that any query that is unlike the few-shot examples may be treated as an out-of-scope query by the LLM. Accordingly, the few-shot examples can provide a form of input validation.

FIG. 6 shows an example response validation process 600 according to some embodiments of the disclosure. In some embodiments, system 100 may perform process 600 at 208 of process 200 in order to receive and validate a response from LLM 120. Output validation can be beneficial because the LLM can hallucinate and can give random responses that are off-track. This can happen based on several factors like incomplete information, wrong or very long input, prompt injection, exceeded token limit, and/or others. Validating the response can safeguard against sending highly inaccurate or unacceptable responses to product 10.

At 602, service layer 110 may receive a response from LLM 120, for example a response to a query as generated and sent through process 500 of FIG. 5 or a similar process. Continuing the tax example, the response may include a natural language response and/or a time estimate responsive to the query (e.g. “You can expect the indicated task to take four hours.”). The GenAI (e.g., LLM 120) can provide an advantage compared to trained ML models because LLM 120 need not be specifically trained on the type of query (e.g., queries related to tax completion time and work capacity), and therefore need not be retrained as facts change (e.g., due to changes in tax laws, changes in tax calculation software, etc.). Accordingly, LLM 120 may be able to generate and send responses quickly in real-time applications, allowing service layer 110 to respond promptly to product 10.

At 604, service layer 110 may validate the response from LLM 120 received at 602. In at least some embodiments, the validating may include processing the response with a validation ML model configured to detect whether the response has an expected characteristic such as presence within an expected range of responses, for example. The ML model can be trained and/or configured to check whether LLM 120 responses are within an expected range. For example, the ML model may be a Python service with a set of defined embeddings that define a range for the response (e.g., expected time should be 1-10 hours, answer should be “yes” or “no”, etc.). As a non-limiting example, some embodiments may use the Pydantic Python library, which is a data validation and serialization library that uses Python type annotations for clarity and validation and supports custom validators and fields for tailored data handling.

Other embodiments may use static checks (e.g., compare LLM 120 response with a table of possible responses) or the like, or a combination of ML and static checks. Rule-based models are often straightforward to implement and interpret, making them suitable for scenarios where the validation criteria are well-defined and static. However, they may lack the flexibility and adaptability of more advanced ML models, especially in handling complex or ambiguous validation tasks. The following are some rule-based static models that may be used alone or in combination with ML models:
1. Data Validation Rules: Define rules to check the validity of individual fields in the response. For example, rules may verify if numeric fields fall within certain ranges, if strings match expected patterns, and/or if certain fields are required.
2. Schema Validation: Define a schema or template for the response structure. Then, compare the actual response against this schema to ensure it conforms to the expected structure. Libraries like JSON Schema or XML Schema can help in this regard.
3. Business Logic Rules: Incorporate domain-specific rules to validate the response based on the business requirements. For instance, if a response contains financial data, rules can apply to ensure that certain calculations or aggregations are correct.
4. Error Handling Rules: Define rules to identify and handle error responses. For example, rules might check for specific error codes or error messages in the response to determine if an error has occurred.
5. Consistency Rules: Check for consistency within the response itself or across multiple responses. This could involve verifying that related fields or entities within the response are coherent and consistent with each other.
6. Regulatory Compliance Rules: If an application needs to comply with certain regulations or standards, incorporate rules to ensure that the response meets these requirements. This could include rules related to data privacy, security, or accessibility.

If the response from LLM 120 is valid, at 606 service layer 110 may proceed to response formatting (e.g., as described below with respect to FIG. 7A). If the response from LLM 120 is not valid, at 608 service layer 110 may prepare a fallback response. The fallback response may include, for example, a message indicating that LLM 120 was unable to generate an answer and/or requesting a rephrased query and/or more information from the user of product 10. In some embodiments, the fallback response may include the response from LLM 120 along with a request to indicate whether the response looks correct or not, so that product 10 can provide feedback to service layer 110 (e.g., see discussion of FIG. 8 below).

FIG. 7A shows an example response object generation process 700 according to some embodiments of the disclosure. In some embodiments, system 100 may perform process 700 at 210 of process 200 in order to format the response from LLM 120 and/or additional information into an object that is useable by product 10.

At 702, service layer 110 may determine a response format. For example, product 10 may have indicated in its initial message including the user query, or in a separate message, a response format to be used. In another example, service layer 110 may look up a response format for product 10. In any event, the response format may be a particular JavaScript Object Notation (JSON) format, such as a JSON graphical UI element, JSON plain text element, etc., in some embodiments. Other embodiments may use response objects other than JSON objects. Generally, the response format may be a format that is useable by product 10 (e.g., JSON graphical UI element to insert into a UI of product 10, JSON plain text element when product 10 is configured to embed text into an interface, etc.). At 704, service layer 110 may generate a response object (e.g., a JSON object) having the determined format and, at 706, service layer 110 may send the response object to product 10.

For example, FIG. 7B shows a first example response in default form 710 and expanded form 720 according to some embodiments of the disclosure. Service layer 110 may generate a JSON object defining an interactive graphical list where a default form 710 can be expanded into expanded form 720 through user interaction such as a click in a UI. The JSON object can define a plurality of labels and values for UI objects as shown. In another example, FIG. 7C shows a second example response 730 according to some embodiments of the disclosure. In this example, service layer 110 can generate a JSON object defining a text response with embedded assets having defined values for display in a text portion of a UI.

FIG. 8 shows an example feedback reinforcement process 800 according to some embodiments of the disclosure. In some embodiments, system 100 may perform process 800 at 212 of process 200 in order to obtain feedback about the response from LLM 120 and, in at least some cases, to update vector DB 130 according to the feedback, thereby creating additional context for future LLM 120 prompts.

At 802, service layer 110 may receive feedback from product 10. For example, product 10 can ask the user through its UI whether the response from LLM 120 was helpful, useful, or otherwise positive. If the user responds, product 10 may send a message indicating the response to service layer 110. The message may indicate whether the feedback was positive or negative, for example. Positive feedback from product 10 may indicate that the response from LLM 120 is acceptable. FIG. 8 illustrates an example where the feedback is positive, but if feedback is negative, service layer 110 may refrain from updating vector DB 130 or may store information indicating the query vector should not be used as future context, for example.

In response to receiving feedback indicating that the response from LLM 120 is acceptable, at 804, service layer 110 may form a vector including the response. This can include converting the response into a context data entry having the standardized format. At 806, service layer 110 may store the context data entry in vector DB 130 as at least a portion of the context data contained therein. As such, future enhanced queries to LLM 120 can include the context data entry.

FIG. 9 shows a computing device 900 according to some embodiments of the disclosure. For example, computing device 900 may function as system 100 and/or any portion(s) thereof, or multiple computing devices 900 may function as system 100 and/or any portion(s) thereof.

Computing device 900 may be implemented on any electronic device that runs software applications derived from compiled instructions, including without limitation personal computers, servers, smart phones, media players, electronic tablets, game consoles, email devices, etc. In some implementations, computing device 900 may include one or more processors 902, one or more input devices 904, one or more display devices 906, one or more network interfaces 908, and one or more computer-readable mediums 910. Each of these components may be coupled by bus 912, and in some embodiments, these components may be distributed among multiple physical locations and coupled by a network.

Display device 906 may be any known display technology, including but not limited to display devices using Liquid Crystal Display (LCD) or Light Emitting Diode (LED) technology. Processor(s) 902 may use any known processor technology, including but not limited to graphics processors and multi-core processors. Input device 904 may be any known input device technology, including but not limited to a keyboard (including a virtual keyboard), mouse, track ball, and touch-sensitive pad or display. Bus 912 may be any known internal or external bus technology, including but not limited to ISA, EISA, PCI, PCI Express, NuBus, USB, Serial ATA or FireWire. In some embodiments, some or all devices shown as coupled by bus 912 may not be coupled to one another by a physical bus, but by a network connection, for example. Computer-readable medium 910 may be any medium that participates in providing instructions to processor(s) 902 for execution, including without limitation, non-volatile storage media (e.g., optical disks, magnetic disks, flash drives, etc.), or volatile media (e.g., SDRAM, ROM, etc.).

Computer-readable medium 910 may include various instructions 914 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 904; sending output to display device 906; keeping track of files and directories on computer-readable medium 910; controlling peripheral devices (e.g., disk drives, printers, etc.) which can be controlled directly or through an I/O controller; and managing traffic on bus 912. Network communications instructions 916 may establish and maintain network connections (e.g., software for implementing communication protocols, such as TCP/IP, HTTP, Ethernet, telephony, etc.).

System 100 components 918 may include instructions for performing the processing described herein. For example, system 100 components 918 may provide instructions for performing any and/or all of processes 200-800, and/or other processing as described above. Application(s) 920 may be an application that uses or implements the outcome of processes described herein and/or other processes. In some embodiments, the various processes may also be implemented in operating system 914.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A method comprising:
obtaining, by at least one processor, active time data indicating a duration of work on a project in a software product;
obtaining, by the at least one processor, preparation time data indicating additional elapsed time between a start and an end of the project;
converting, by the at least one processor, the active time data and the preparation time data into a data entry having a standardized format and storing the data entry in a database;
identifying, by the at least one processor, context data in the database;
generating, by the at least one processor, a large language model (LLM) prompt comprising a structured combination of a query, the database entry, and the context data;
sending, by the at least one processor, the LLM prompt to an LLM and receiving a response from the LLM;
validating, by the at least one processor, the response; and
in response to the validating, sending, by the at least one processor, the response to the software product.

2. The method of claim 1, wherein the active time data comprises a record of active user interaction with the project in the software product.

3. The method of claim 1, wherein the preparation time data comprises a record of at least a portion of an elapsed time between an initiation of the project and a completion of the project.

4. The method of claim 1, wherein:
the converting comprises forming a vector including the active time data and the preparation time data; and
the database comprises a vector database.

5. The method of claim 1, further comprising including, by the at least one processor, user characteristic data into the data entry having the standardized format prior to the storing.

6. The method of claim 1, wherein the identifying comprises retrieving at least one record of a previously successful data entry in the standardized format that resulted in a previously validated response from the LLM.

7. The method of claim 1, wherein the validating comprises processing the response with a validation machine learning (ML) model configured to detect whether the response has an expected characteristic.

8. The method of claim 7, wherein the expected characteristic comprises presence within an expected range of responses.

9. The method of claim 1, further comprising converting, by the at least one processor, the response into a context data entry having the standardized format and storing the context data entry in the database as at least a portion of the context data.

10. The method of claim 9, further comprising receiving, by the at least one processor, feedback from the software product indicating the response is acceptable, wherein the converting of the response is performed in response to the receiving of the feedback.

11. A system comprising:
at least one processor; and
at least one non-transitory computer-readable medium configured to store instruction that, when executed by the at least one processor, cause the at least one processor to perform processing comprising:
obtaining active time data indicating a duration of work on a project in a software product;
obtaining preparation time data indicating additional elapsed time between a start and an end of the project;
converting the active time data and the preparation time data into a data entry having a standardized format and storing the data entry in a database;
identifying context data in the database;
generating a large language model (LLM) prompt comprising a structured combination of a query, the database entry, and the context data;
sending the LLM prompt to an LLM and receiving a response from the LLM;
validating the response; and
in response to the validating, sending the response to the software product.

12. The system of claim 11, wherein the active time data comprises a record of active user interaction with the project in the software product.

13. The system of claim 11, wherein the preparation time data comprises a record of at least a portion of an elapsed time between an initiation of the project and a completion of the project.

14. The system of claim 11, wherein:
the converting comprises forming a vector including the active time data and the preparation time data; and
the database comprises a vector database.

15. The system of claim 11, the processing further comprising including user characteristic data into the data entry having the standardized format prior to the storing.

16. The system of claim 11, wherein the identifying comprises retrieving at least one record of a previously successful data entry in the standardized format that resulted in a previously validated response from the LLM.

17. The system of claim 11, wherein the validating comprises processing the response with a validation machine learning (ML) model configured to detect whether the response has an expected characteristic.

18. The system of claim 17, wherein the expected characteristic comprises presence within an expected range of responses.

19. The system of claim 11, the processing further comprising converting the response into a context data entry having the standardized format and storing the context data entry in the database as at least a portion of the context data.

20. The system of claim 19, further comprising receiving, by the at least one processor, feedback from the software product indicating the response is acceptable, wherein the converting of the response is performed in response to the receiving of the feedback.
